(19) United States
(12) Patent Application Publication
(10) Pub. No.: US 2004/0069879 A1
(43) Pub. Date: Apr. 15, 2004

(54) Cutting device, particularly for comminuting chips

(76) Inventors: Bruno Binder, Dornhan (DE); Lothar Habermehl, Butzbach-Griedel (DE)

Correspondence Address: BIRCH STEWART KOLASCH & BIRCH, PO BOX 747, FALLS CHURCH, VA, 22040-0747, US

(21) Appl. No.: 10/358,203

(22) Filed: Feb. 5, 2003

(30) Foreign Application Priority Data
Feb. 5, 2002 (DE) DE 102 04 772.3

(51) Int. Cl. B02C 18/16

(52) U.S. Cl. 241/30; 241/243

(57) ABSTRACT

The invention relates to a cutting device, in particular for comminuting chips, with at least one cutting blade and at least one rotating feed blade arranged on a longitudinal axis, wherein the feed blade or blades in the feed section of the cutting device works together with the cutting blade or blades.

This non-provisional application claims priority under 35 U.S.C. § 119(a) on Patent Application No. DE 102 04 772.3, filed in Germany on Feb. 5, 2002, which is herein incorporated by reference.

### BACKGROUND OF THE INVENTION

1. Field of the Invention

The present invention relates to a cutting device, particularly for comminuting chips, and also to a method for operating a cutting device.

2. Description of the Background Art

A conventional cutting device is known from DE 42 37 683 A1, which discloses a comminution blade for a material comminution apparatus for comminuting long chips, in particular metal or plastic chips. The cutting device has a chip feed device that continuously feeds chip material, and an opposing blade with an opposing cutting edge. Provision is made for the comminution blade to take the form of a driven rotating body that has at its end a casing with at least one inclined plane, and for the body to rotate such that a fed chip is moved to the opposing cutting edge by the inclined plane of the rotating body until it strikes the opposing cutting edge, and for the chip in contact with the opposing cutting edge to be cut off by at least the upper region of the inclined plane.

EP 0 712 663 A1 discloses a cutting device with a chip comminution chamber and a drum that pivots about its longitudinal axis in the chip comminution device, wherein cutting blades are arranged in a spiral and are located on the periphery of the drum, run onto appropriately designed opposing blades arranged on the longitudinal side of the chip comminution chamber. Located beneath the drum is a sieve matched to the radius of the drum, and beneath the sieve is a chip collecting chamber.

Such a cutting device, however, has low throughput and chip quality.

### SUMMARY OF THE INVENTION

It is therefore an object of the present invention is to provide an improved cutting device. This object is attained in accordance with the invention by a cutting device with at least one cutting blade and at least one rotating feed blade arranged on a longitudinal axis, wherein the feed blade or blades in the feed section of the cutting device work together with the cutting blade or blades.

The comminution output is increased due to the fact that the comminution of chips starts in the feed section by the interaction of the feed and cutting blades. Automatic regulation of the chip feed occurs, as the feed blade or blades only draw in as many chips for comminution as can actually be comminuted. As a result of the relatively large receiving area of the feed section, appropriately extensive immediate comminution can take place, so little or no compression of the uncomminuted chips takes place. This prevents blocking or jamming of the cutting device, resulting from too many compressed chips being fed. The torque that the drive must supply is reduced, thus reducing the power consumption and reducing the required drive power, with the result that smaller motors can be used. As a result of the fact that no extreme load peaks or overloads occur, the service life of the feed and cutting blades, and also of the drive, can be extended. Moreover, the cutting device runs more quietly. To this end, it is preferred for the feed blade or blades to be moved while the cutting blade or blades remain stationary. Furthermore, it is preferable for the feed blade or blades to have a rotationally symmetrical design.

Preferably the longitudinal axis that the feed blade or blades are arranged along is oriented in the vertical direction. In a preferred embodiment, multiple feed blades are arranged in alternation with cutting blades.

In accordance with a preferred embodiment, the chip feed is provided in the horizontal direction, in particular in the form of a screw conveyor. The screw conveyor can be driven as a function of the load on the cutting device in such a way that, in the event of an overload, the screw conveyor can be stopped or operated in reverse until the overload condition is over.

Preferably the cutting device is equipped with at least one stationary cutting blade that is arranged on the longitudinal axis and has multiple cutting edges. In accordance with a preferred embodiment, the cutting blade or blades has at least two, preferably three, different forms of cutting edges. Provided in the feed section are cutting edges with a saw-like design, which have a smaller outside diameter than the feed blades, and whose actual cutting surface runs in an approximately radial direction. In the vicinity of the side walls of the housing, which is located adjacent to the feed section, other types of cutting edges are provided that work together with the side walls of the housing, wherein the side wall, which is the first thing after the feed section passed by the feed blades, serves as a feed plate. Moreover, additional cutting edges are provided, by which recutting is accomplished. The outside diameters of the two last-mentioned types of cutting edges are approximately the same as the outside diameter of the feed blade or blades here.

In accordance with a preferred embodiment, the cutting device has at least two feed blades which are arranged at an offset to one another, in particular in the form of a helix. It is advantageous for installation of the feed blades to be simplified in that the shaft upon which the feed blades are seated in a positive locking manner has a suitable, repeating profile, for example a multigroove profile, a serrated profile, or a spline profile, that corresponds to the inside profile of the feed blades.

In a further embodiment, the cutting device has a perforated plate that is provided in the longitudinal direction of the longitudinal axis in the bottom section of the cutting device. In this context, the perforated plate has holes, preferably in the form of slotted holes, that are arranged about the longitudinal axis, especially in an equidistant manner.

It is advantageous for a feed blade to be arranged in front of the perforated plate, and a rotating separator plate to be arranged behind the perforated plate, so that small chip chambers are formed. The chip chambers are opened alternately to the top and to the bottom as a function of the rotation of the shaft, and hence of the feed blade that is rigidly attached thereto, and of the separator plate. In the process, chips are pushed into the chip chambers by the feed blade, the feed chambers are covered and then opened again to be filled with chips again. Accordingly, the chip chambers are first held closed at the bottom by the perforated plate, then opened and closed again. The separator plate can be arranged at a distance of approximately 0.5 to 1 mm from the perforated plate in this context.

In a further embodiment, the cutting edges of the feed blade are V-shaped. In this way, the chips to be fed are gathered optimally and can be comminuted by the cutting edges of the cutting blade.

Further, the generating angle of the cutting edges of the feed blade is 45° to 60° in the direction of rotation, preferably approximately 55°.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus, are not limitive of the present invention, and wherein:

FIG. 1 is a side view of a cutting device according to a preferred embodiment;

FIG. 2 is a sectional view along line II-II in FIG. 1;

FIG. 3 is a top view of a feed blade;

FIG. 4 is a top view of a cutting blade;

FIG. 5 is a top view of a perforated plate; and

FIG. 6 is a top view of a separator plate.

### DETAILED DESCRIPTION OF THE PREFERRED EMBODIMENTS

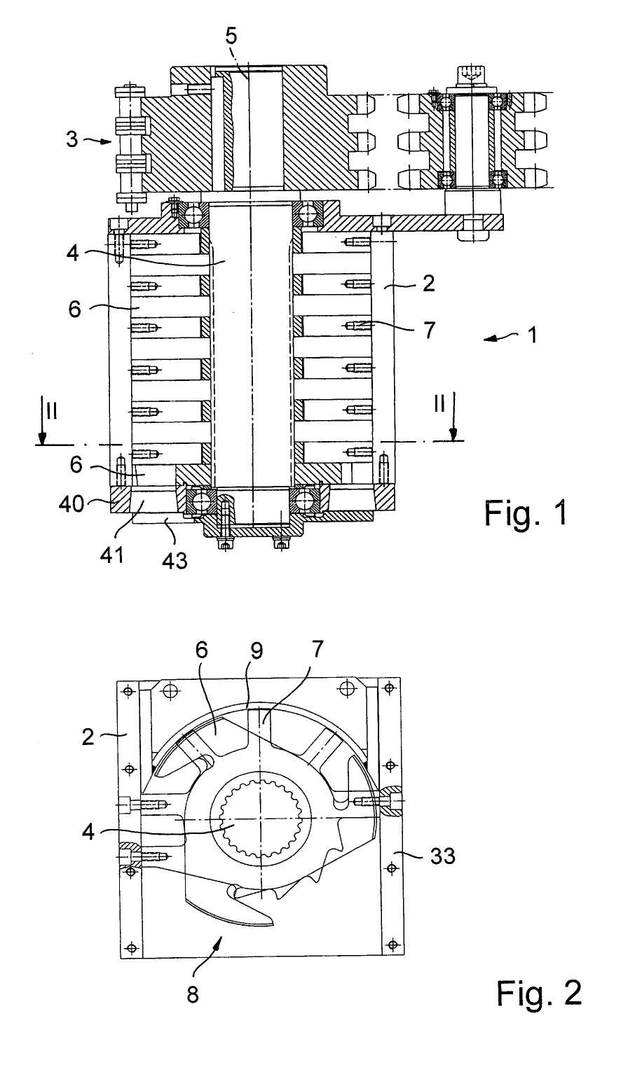

FIG. 1 shows a cutting device 1 with a housing 2. The cutting device 1 is used in particular for the comminution of aluminum chips, but it can also be used for comminuting other types of chips, such as steel chips for example. The cutting device 1 includes, in the top section of FIG. 1, a drive 3 which drives a shaft 4 that is carried by two ball bearings. A longitudinal axis 5 of the shaft 4 is shown in FIG. 1 to be in a vertical direction.

Arranged on the shaft 4 are six feed blades 6, offset relative to one another along the longitudinal axis 5 such that they form a sort of helix. Even spacing is ensured by a serrated profile of the shaft 4 and of the feed blades 6. Furthermore, the cutting device 1 also has six stationary cutting blades 7, which are also arranged with respect to the longitudinal axis 5, but all with the same orientation. The feed blades 6 and the cutting blades 7 are alternately arranged. The front, open section of the housing 2 serves to feed the chips and is referred to below as feed section 8. The feeding of chips is accomplished by, for example, a screw conveyor (not shown), which is arranged approximately in the horizontal direction and ends close to the front of the cutting device 1. The feed can be regulated, in particular restricted, by a baffle plate, for example, which may be necessary in the case of aluminum chips. Moreover, the chip feed can be regulated by intermittent operation and/or by briefly running the conveyor screw in reverse in order to avoid blockages. To avoid overloads, suitable sensors (for example, monitoring the power consumption of the drive motor, monitoring the rotational speed of the shaft, optical and/or acoustic monitoring) can be provided that slow or stop the feeding of the chips at elevated loads. Located in the rear section of the housing 2, opposite the feed section 8, is a screening plate 9, which serves to separate out excess fluid.

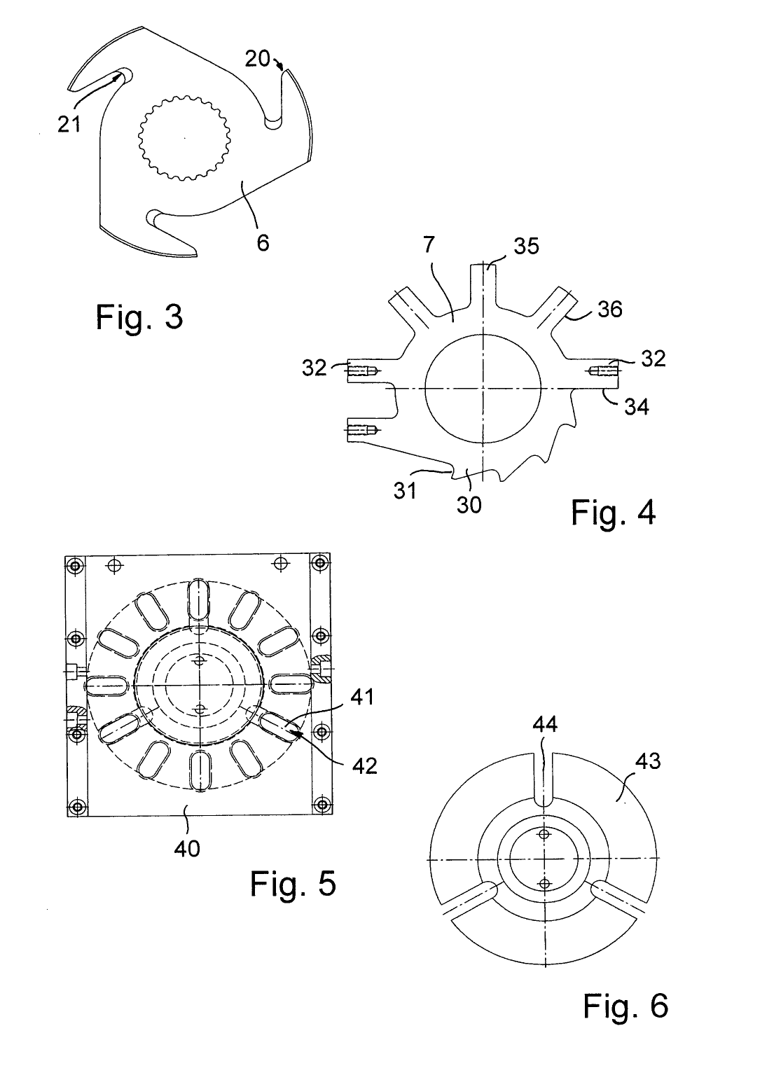

The feed blades 6 are rotationally symmetrical, as can be seen in FIG. 3, and in the example embodiment shown, have three cutting edges 20 that open in the direction of rotation. The outside diameter of the feed blade 6 is 180 mm. The generating angle of the cutting edges 20 is approximately 55 at the inlet, and narrows counter to the direction of rotation, where the inner region 21 ends in a radius. The cutting edges 20 are slightly inclined on one side, as can be seen in the top view in FIG. 3.

The cuffing blades 7 are designed such that four saw-like cutting edges 30, which have a smaller outside diameter than the feed blades 6, are provided in the feed section 8, wherein the actual cutting surface runs approximately in a radial direction. These cutting edges are referred to below as preliminary cut cutting edges 31. Provided in the vicinity of the side walls of the housing 2, located adjacent to the feed section 8, are cutting edges 32, which work together with the side walls of the housing 2, wherein the side wall, which is the first thing after the feed section 8 that is passed by the feed blades 6, serves as the feed plate 33. The chamber cut is accomplished by the cutting edges 32, for which reason these cutting edges 32 are called chamber cut cutting edges 34 hereinbelow. Also, three additional cutting edges 35 are provided, which accomplish the recutting, for which reason these cutting edges 32 are called recut cutting edges 36 hereinbelow. The screening plate 9 is placed at the ends 37 of the recut cutting edges 36.

Provided in the bottom section of the housing 2 is a thicker, hardened perforated plate 40 (see FIG. 5), that has small chip chambers 41 in the form of slotted holes 42. In this example, the slotted holes 42 are arranged about the longitudinal axis 5 in a star configuration. A short distance, e.g. 0.5 to 1 mm, beneath the perforated plate 40 a rotating, likewise hardened separator plate 43 (see FIG. 6) is provided, which is connected to the shaft 4 and has three equidistant radial slots 44. The separator plate 43 is mounted on the shaft 4 in such a way that the slots 44 are covered by the feed blade 6 located thereabove.

Beneath the separator plate 43 is a large chip chamber (not shown), which can serve as (intermediate) storage for the comminuted chips. A perforated plate 40 and a rotating separator plate 43 are not necessarily required, but do optimize comminution of the chips.

The cutting process takes place as follows: chips are fed through the front opening in the housing 2 by the screw conveyor, are collected and drawn in by the rotating feed blades 6 in the feed section 8, which then comminute some of them directly in the feed section 8 by cooperation with the stationary cutting blades 7, specifically the preliminary cut cutting edges 31. The feed blades 6 rotate from 5 to 30 RPM. The remaining chips are drawn in further by the feed blades 6, and are further comminuted at the feed plate 33 in conjunction with the chamber cut cutting edges 34. Further comminution of the chips is accomplished in the rear section of the cutting device 1 by the recut cutting edges 36. In the process, chips fall downward from the uppermost recut cutting edge 36, and are held back and cut again by the feed blade 6 located thereunder, etc. When the comminuted chips reach the perforated plate 40, they are pushed by the adjacent feed blade 6 into one of the small chip chambers 41, which at this time is closed at the bottom by the separator plate 43. The separator plate 43 subsequently opens the chip chambers 41 so that the chips fall downward into the large chip chamber, which is not shown, where they are collected in order to be transported away at a later time. On account of the comminution the chips take up significantly less space than in their original state with the result that they can be stored, transported and further processed more easily after comminution.

The screw conveyor feeds the cutting device 1 in a load-driven manner, which is to say that as soon as the cutting device 1 has reached a predetermined load, the screw conveyor is briefly run back and stopped. Once the cutting device 1 is again working in the lower load region, the screw conveyor is driven again and conveys chips to the cutting device 1.

The cutting device 1 requires 1.5 kW drive power at a rotational speed of 10 RPM, which represents approximately 2 liter of chips/min., such that after comminution the chips are available in the form of, for example, an easily pumped bulk material. The proportion of superfine particles is very low here, so no problems occur in filtering, and the average chip length is approximately 40 mm, with no relatively great outliers in chip length, regardless of whether steel or aluminum is comminuted.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cutting device for comminuting chips, comprising:
at least one cutting blade and
at least one rotating feed blade arranged on a longitudinal axis, wherein the at least one feed blade in the feed section of the cutting device works in conjunction with the at least one cutting blade.

2. The cutting device according to claim 1, wherein the longitudinal axis is oriented in a vertical direction.

3. The cutting device according to claim 1, wherein a chip feed is provided in a horizontal direction.

4. The cutting device according to claim 1, wherein a screw conveyor is provided for feeding the chips.

5. The cutting device according to claim 1, wherein the at least one cutting blade is arranged on the longitudinal axis and has multiple cutting edges.

6. The cutting device according to claim 1, wherein the at least one cutting blade includes at least two different forms of cutting edges.

7. The cutting device according to claim 1, further comprising a side plate, which is arranged at a distance from the at least one feed blade.

8. The cutting device according to claim 1, wherein at least two feed blades are provided, which are arranged at an offset to one another.

9. The cutting device according to claim 8, further comprising a shaft, upon which the at least one feed blade is arranged and has, at least in the region in which the at least one feed blade is located, a profile that repeats over the circumference of the shaft, which interlocks in a positive manner with the corresponding inside profile of the at least one feed blade.

10. The cutting device according to claim 1, further comprising a perforated plate, which is provided in the longitudinal direction of the longitudinal axis.

11. The cutting device according to claim 10, wherein the perforated plate has slotted holes.

12. The cutting device according to claim 10, wherein openings in the perforated plate are arranged about the longitudinal axis and form small chip chambers.

13. The cutting device according to claim 10, wherein the at least one feed blade is arranged in front of the perforated plate, and a rotating separator plate is arranged behind the perforated plate.

14. The cutting device according to claim 12, wherein the small chip chambers of the perforated plate are open alternately to the top and to the bottom.

15. The cutting device according to claim 13, wherein the separator plate is arranged a certain distance away from the perforated plate.

16. The cutting device according to claim 1, wherein the at least one feed blade has cutting edges, said cutting edges having a V-shape.

17. The cutting device according to claim 16, wherein the generating angle of the cutting edges of the at least one feed blade is 45° to 60° in the direction of rotation.

18. The cutting device according to claim 16, wherein the generating angle of the cutting edges of the at least one feed blade is 55° in the direction of rotation.

19. The cutting device according to claim 1, wherein at least one cutting blade is stationary.

20. A method for operating a cutting device, the steps comprising:
gathering chips into a feed section by at least one feed blade, which is rotating about a longitudinal axis; and
comminuting a portion of the chips in the feed section by the cooperation of the at least one feed blade with at least one stationary cutting blade.

21. The method according to claim 18, wherein chip transport is regulated as a function of a load on the cutting device.

22. The method according to claim 18, wherein chip chambers, provided in the bottom section of the cutting device, are opened towards a bottom and a top in alternation.
